(19) United States
(12) Patent Application Publication
(10) Pub. No.: US 2012/0084771 A1
(43) Pub. Date: Apr. 5, 2012

(54) Communication Device and Management Method

(76) Inventors: Ayumi Hashimoto, Akishima-shi (JP); Hideki Ohkita, Kunitachi-shi (JP); Hideyuki Nakagawa, Koganei-shi (JP)

(21) Appl. No.: 13/154,252

(22) Filed: Jun. 6, 2011

(30) Foreign Application Priority Data
Sep. 30, 2010 (JP) 2010-223183

(51) Int. Cl. G06F 9/445; G06F 15/16

(52) U.S. Cl. 717/176

(57) ABSTRACT

A communication device includes a communication module, an installation module and an storage module. The communication module is configured to communicate with an external device based on a certain communication protocol. The installation module is configured to install a first application that performs communication using the communication module. The storage module is configured to store first information about the certain communication protocol and second information about the first application in a storage medium while associating the first information and the second information with each other when the first application is installed.

### CROSS REFERENCE TO RELATED APPLICATION (S)

The present disclosure relates to the subject matters contained in Japanese Patent Application No. 2010-223183 filed on Sep. 30, 2010, which are incorporated herein by reference in its entirety.

### FIELD

An embodiment described herein relates generally to a communication device and a management method.

### BACKGROUND

Communication devices in which lots of applications are able to be installed have been developed and put into wide use with the recent advance in technology.

For example, some of these applications can perform a process of transferring sound files or image files. This transfer process is generally performed based on a communication protocol defined by each of the applications.

On the other hand, some of the communication devices are able to communicate with other communication devices by a plurality of communication protocols.

### BRIEF DESCRIPTION OF THE DRAWINGS

A general configuration that implements the various feature of the invention will be described with reference to the drawings. The drawings and the associated descriptions are provided to illustrate an embodiment of the invention and not to limit the scope of the invention.

FIG. 1 shows a schematic view showing an example of a communication system in an embodiment.

FIG. 2 is a block diagram showing an example of main part of internal configuration of a mobile device and a PC in the embodiment.

FIG. 3 is a conceptual view showing an example of information shown on a table in the embodiment.

FIG. 4 is a sequence diagram showing an example of processing using the table in the embodiment.

FIG. 5 is a conceptual view showing an example of display on the mobile device after establishment of first communication in the embodiment.

FIG. 6 is a conceptual view showing an example of display on the mobile device after establishment of second communication in the embodiment.

FIG. 7 is a flow chart showing an example of a flow of processing performed by the mobile device in the embodiment.

### DETAILED DESCRIPTION

According to one embodiment, a communication device includes a communication module, an installation module and an storage module. The communication module is configured to communicate with an external device based on a certain communication protocol. The installation module is configured to install a first application that performs communication using the communication module. The storage module is configured to store first information about the certain communication protocol and second information about the first application in a storage medium while associating the first information and the second information with each other when the first application is installed.

An embodiment of the invention will be described below with reference to the drawings.

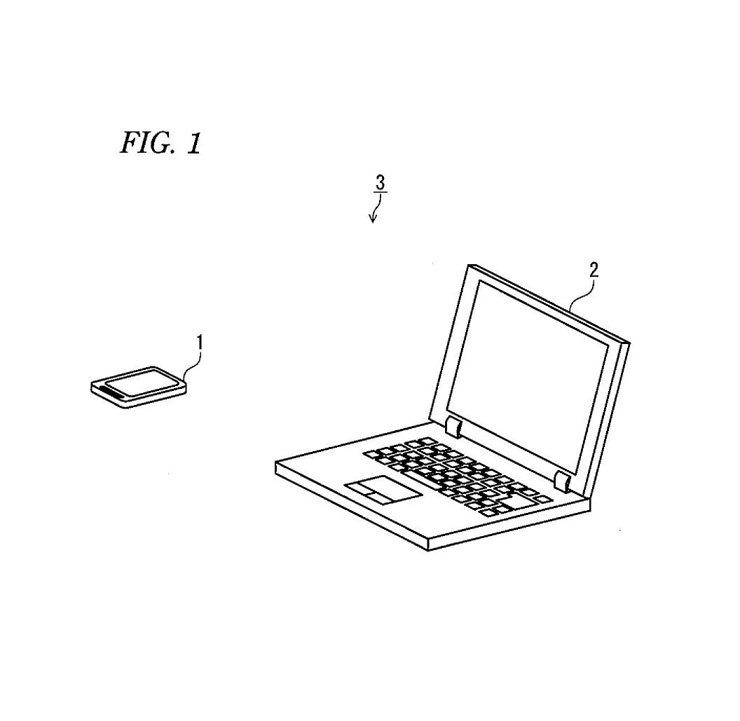

FIG. 1 is a schematic view showing an example of a communication system in the embodiment.

A communication system 3 in the embodiment includes a mobile device 1 and a PC 2.

The mobile device 1 is an example of a communication device in the embodiment. For example, the mobile device 1 is an electronic device such as a smartphone. A plurality of applications are able to be installed in the mobile device 1. For example, applications downloaded from a communication network such as Internet are able to be installed in the mobile device 1. Moreover, icons for performing the installed applications are displayed on the mobile device 1 so that a user can run a target application by selecting one of the icons.

The PC 2 is an information processing device such as a personal computer provided with a plurality of applications. The PC 2 is also formed so that applications downloaded from a communication network such as Internet are able to be installed in the PC 2 in the same manner as the mobile device 1.

The mobile device 1 and the PC 2 can communicate with each other by a plurality of (two in the embodiment) communication protocols, so that the mobile device 1 and the PC 2 are able to exchange data such as sound files, image files, etc. with each other.

Next, the internal configuration of the mobile device 1 and the PC 2 will be described.

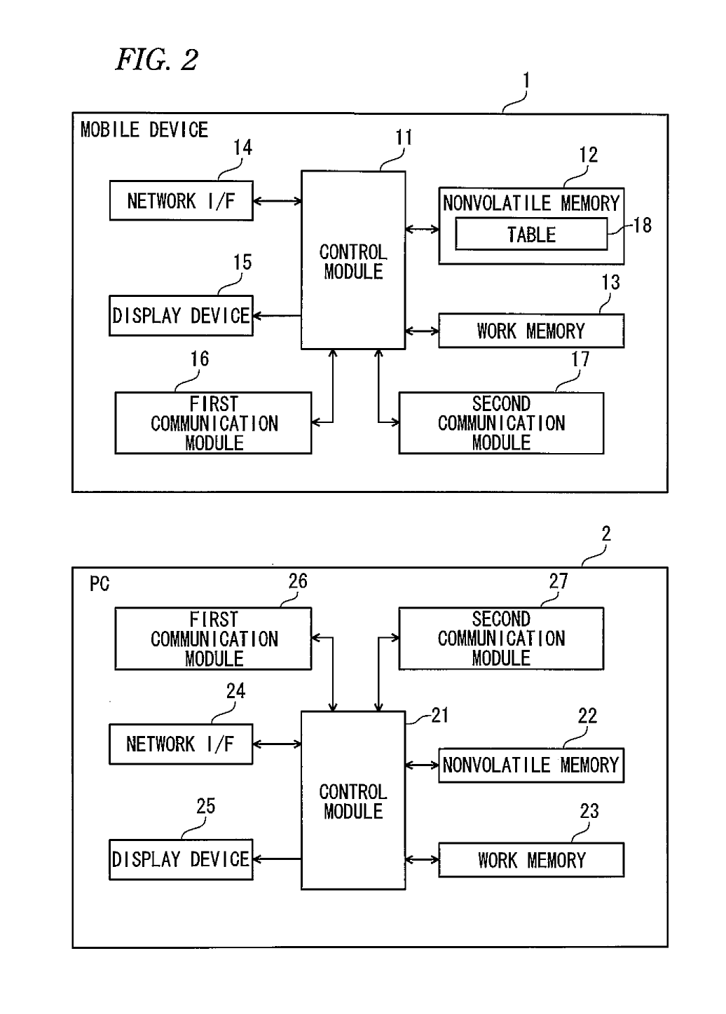

FIG. 2 is a block diagram showing an example of main part of the internal configuration of the mobile device 1 and the PC 2 in the embodiment.

The mobile device 1 has a control module 11, a nonvolatile memory 12, a work memory 13, a network I/F 14, a display device 15, a first communication module 16, and a second communication module 17.

The control module 11 is a processing module such as a Central Processing Unit (CPU) for performing various processes and has a function of generally controlling the mobile device 1.

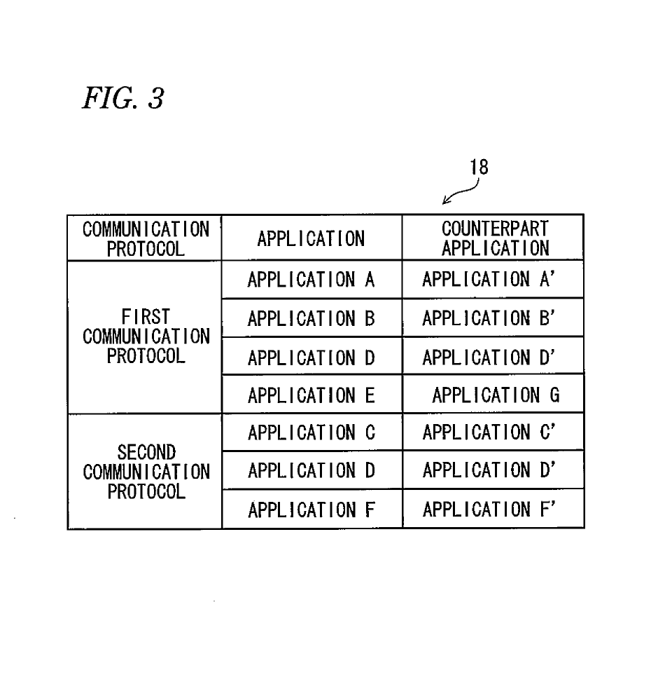

The nonvolatile memory 12 is a nonvolatile storage medium which stores programs performed by the control module 11, data used for processing, etc. For example, the nonvolatile memory 12 stores various kinds of information such as programs of various applications downloaded and installed in the mobile device 1, data used for these programs, etc. The nonvolatile memory 12 further stores a table 18 indicating relationship between applications and corresponding communication protocols used by the applications respectively. Details of the table 18 will be described later with reference to FIG. 3.

The work memory 13 is a work area which is used when the control module 11 performs various processes. The control module 11 reads various programs, data etc. from the nonvolatile memory 12, loads the various programs, the data etc. into the work memory 13 and performs various processes on the work memory 13.

The network I/F 14 is an interface which is connectable to a large-scale network such as Internet, so that the control module 11 can receive/transmit various data from/to the network through the network I/F 14. Specifically, the control module 11 can search for an application existing on the network or download an application desired by a user from the network through the network I/F 14.

The display device 15 has a display panel such as a Liquid Crystal Display (LCD). The display device 15 is able to display an image output from the mobile device 1.

The first communication module 16 performs wireless communication with an external device in accordance with a specific communication protocol. The first communication module 16 performs communication based on a TransferJet (registered trademark) protocol, for instance, which is a first communication protocol in the embodiment. TransferJet is a protocol of short-range wireless transfer technology and is a communication protocol that communication between communication modules starts automatically when the communication modules come close to each other. After the start of the communication, a user is able to exchange (transmit/receive) data between communication devices.

The second communication module 17 is a communication module which performs wireless communication with an external device in accordance with a specific communication protocol. The second communication module 17 performs communication based on a Bluetooth (registered trademark) protocol, for instance, which is a second communication protocol in the embodiment. Bluetooth is a protocol of short-range wireless communication technology and is such a communication specification that devices having communication modules are authenticated by each other and are allowed to communicate with each other after the authentication.

The PC 2 has a control module 21, a nonvolatile memory 22, a work memory 23, a network I/F 24, a display device 25, a first communication module 26, and a second communication module 27. The same names as those of modules of the mobile device 1 are given to modules of the PC 2 with respect to the internal configuration of the PC 2 because modules of the PC 2 have substantially the same functions of those of the mobile device 1. Detailed description of the internal configuration of the PC 2 will be omitted.

Although this embodiment will be described when the first communication modules 16 and 26 are TransferJet communication modules and the second communication modules 17 and 27 are Bluetooth communication modules, the embodiment is not limited to this case. For example, each communication module may be a wireless communication module for performing communication based on another wireless communication specification such as Infrared Data Association (IrDA), or may be a wire communication module for performing communication based on a wire communication specification such as Local Area Network (LAN) or High-Definition Multimedia Interface (HDMI).

Applications by which the mobile device 1 and the PC 2 are able to exchange data with each other are provided so that a communication specification for performing the data exchange is defined in each of the applications. For example, a certain application uses the first communication modules 16 and 26 to perform data transfer in accordance with the TransferJet specification. As described above, the mobile device 1 in this embodiment stores relationship between applications and corresponding communication protocols used by the applications respectively as the table 18. In addition, when the mobile device 1 intends to transfer data to the PC 2 by using a certain application, an application corresponding to the certain application and provided for receiving data transferred by the certain application at the mobile device 1 needs to be installed in the PC 2. An application which corresponds to the certain application installed in the mobile device 1 and which is installed in the PC 2 to receive data from the certain application installed in the mobile device 1 (or transmit data to the certain application installed in the mobile device 1) as described above is here referred to as a “counterpart application” (a second application necessary for the external device when the first application communicates with the external device).

The table 18 stored in the mobile device 1 in the embodiment indicates relationships among communication protocols, corresponding applications at the mobile device 1, and corresponding counterpart applications.

FIG. 3 is a conceptual view showing an example of information indicated by the table 18 in the embodiment.

The table 18 indicates relationships among communication protocols available on the mobile device 1, corresponding applications for performing data transfer by using the communication protocols, and counterpart applications.

For example, applications installed in the mobile device 1 for performing data transfer by using the first communication protocol (TransferJet) in FIG. 3 are application A, application B, application D and application E. On the other hand, applications corresponding to these applications and needed to be installed in the PC 2 for the data transfer, that is, counterpart applications are application A′, application B′, application D′ and application G.

That is, with respect to the application A, the application A performs data transfer based on the first communication protocol (TransferJet) and the application on the PC 2 (i.e. the counterpart application) which can perform data exchange with the application A by using the first communication protocol (TransferJet) is application A′.

Moreover, applications installed in the mobile device 1 for performing data transfer by using the second communication protocol (Bluetooth) are application C, application D and application F. On the other hand, applications corresponding to these applications and needed to be installed in the PC 2 for the data transfer, that is, counterpart applications, are application C′, application D′ and application F′.

When, for example, an application is downloaded from a network and then installed in the mobile device 1, information of a communication protocol used by the application and a counterpart application corresponding to the application is stored in the table 18.

Processing using the table 18 will be described next.

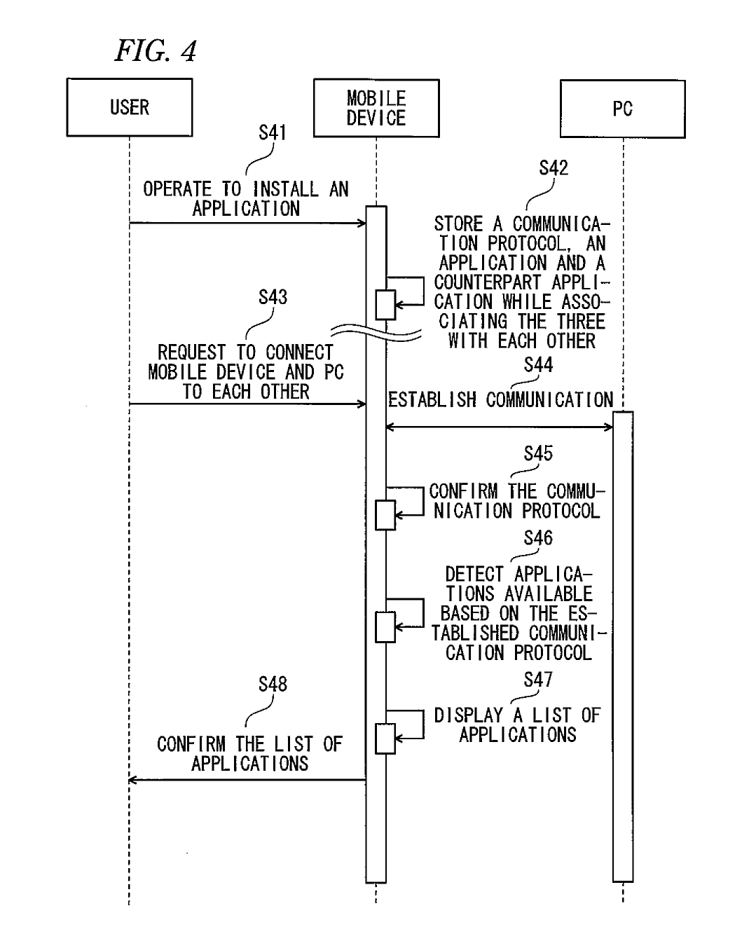

FIG. 4 is a sequence diagram showing an example of processing using the table 18 in the embodiment.

First, when, for example, a user downloads an application from a network and installs the application into the mobile device 1 (step S41), the mobile device 1 acquires information of a communication protocol used by the application and a counterpart application corresponding to the application, and stores the information in the table 18 (step S42). The embodiment is described when the information of the communication protocol used by the application and the counterpart application corresponding to the application is acquired based on meta information of the application. However, the information acquiring method is not limited thereto. Various other methods may be conceived. For example, information about the application may be acquired by searching the network or may be acquired based on information obtained by automatic start of the application. Or when the application is performed by the user so that data are exchanged, information of a communication protocol corresponding to the application and a counterpart application corresponding to the application may be acquired into the table 18.

When the mobile device 1 then accepts a connection request from the user to connect the mobile device 1 and the PC 2 to each other by a certain communication protocol (step S43), the mobile device 1 and the PC 2 establish communication based on the communication protocol (step S44).

When the communication is established in the step S44, the mobile device 1 confirms the communication protocol of the established communication (step S45). When the communication protocol of the established communication is confirmed, the mobile device 1 detects available applications based on the established communication protocol (step S46). That is, the mobile device 1 detects applications corresponding to the established communication protocol from the table 18.

When applications available based on the established communication protocol are detected in the step S46, the mobile device 1 displays a list of the detected applications (step S47) so that the user is able to confirm the applications available based on the established communication protocol (step S48).

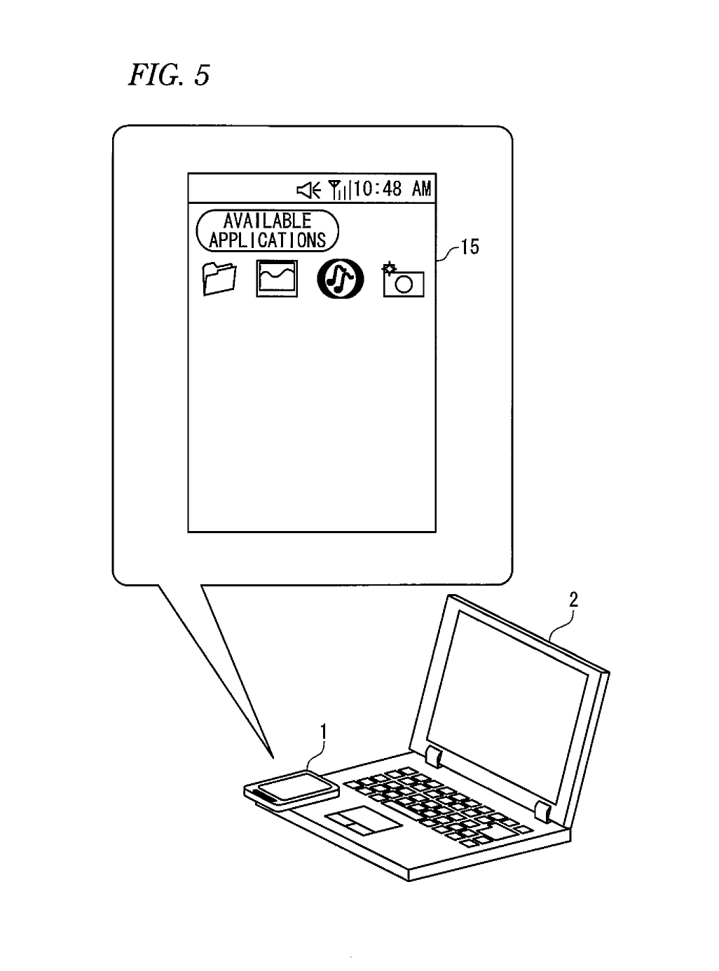

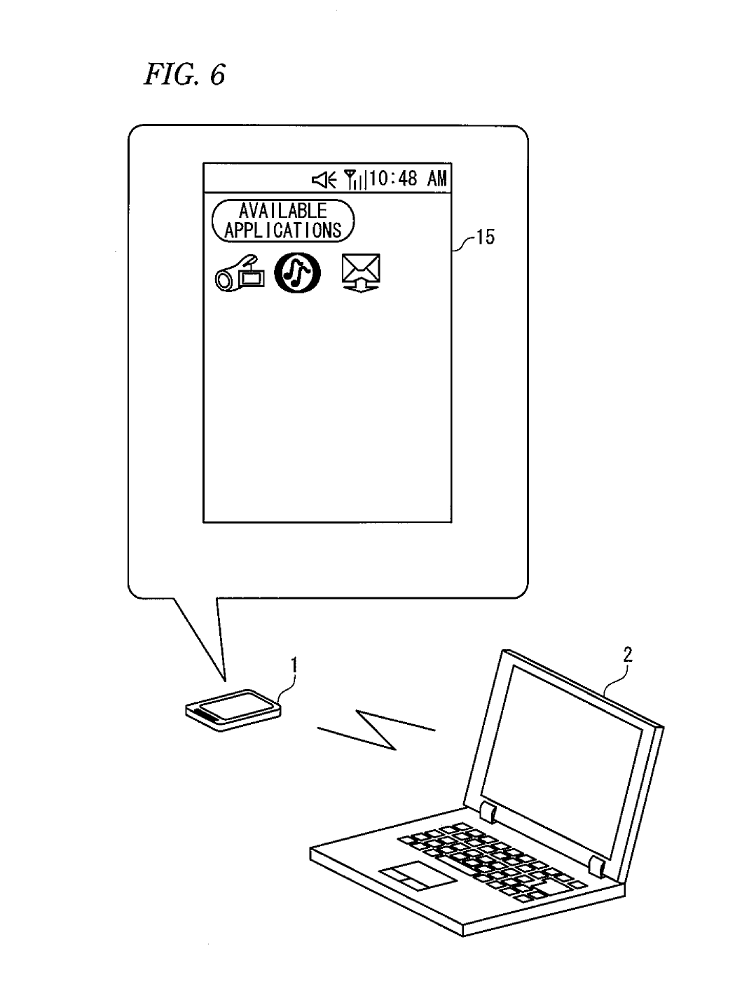

In the embodiment, the applications available based on the established communication protocol are displayed as icons on the mobile device 1. FIGS. 5 and 6 show examples of display on this occasion.

FIG. 5 is a conceptual view showing an example of display on the mobile device 1 after establishment of first communication in the embodiment.

FIG. 5 shows exemplary display on the mobile device 1 when the user brings an antenna module of the first communication module 16 of the mobile device 1 close to an antenna module of the first communication module 26 of the PC 2 so that the mobile device 1 and the PC 2 establish communication based on the first communication protocol (TransferJet).

Icons of application A, application B, application D and application E associated with the first communication protocol by the table 18 are displayed in the display device 15 of the mobile device 1. The user is able to confirm by the icons the applications available based on the currently established communication protocol. When, for example, the user forgets or does not recognize the applications available based on the first communication protocol, the user are able to confirm the applications available based on the established communication protocol again so that user-friendliness is improved. Moreover, when the user selects one from the applications displayed in the display device 15 of the mobile device 1 in the embodiment, the control module 11 serves as a starter module which starts up the application indicated by the selected icon. Accordingly, user-friendliness is further improved. Selection of the application can be performed when the user operates an operation module not shown. Various operation modules such as various operation buttons provided in the mobile device 1, a touch panel provided on the display device 15, etc. may be conceived as examples of the operation module.

When the user operates the mobile device 1 to establish communication with an external device (the PC 2 in the embodiment), the user may likely have the intention of performing communication with the external device based on this communication protocol. That is, because the user first wants to perform communication at the point of time that the communication has been established, display of applications available based on this communication protocol in the display device 15 is preferred rather than display of icons for a large number of applications irrelevant to communication in the display device 15. When, for example, a large number of applications are installed in the mobile device 1, display of only applications available based on the established communication protocol particularly makes it possible to narrow candidates for an application to be used so that the user's time and effort required to search the application are able to be saved. That is, it becomes easy to select the application to be used so that user-friendliness is improved.

FIG. 6 is a conceptual view showing an example of display on the mobile device 1 after establishment of second communication in the embodiment.

FIG. 6 shows exemplary display on the mobile device 1 when the mobile device 1 and the PC 2 establish communication based on the second communication protocol (Bluetooth) in accordance with a user's instruction.

Icons of application C, application D and application F which are associated with the second communication protocol by the table 18 are displayed in the display device 15 of the mobile device 1.

Here, applications available based on the second communication protocol are displayed on the mobile device 1 when the mobile device 1 performs communication with the PC 2 by a certain application based on the second communication protocol.

A flow of processing in the mobile device 1 will be described next.

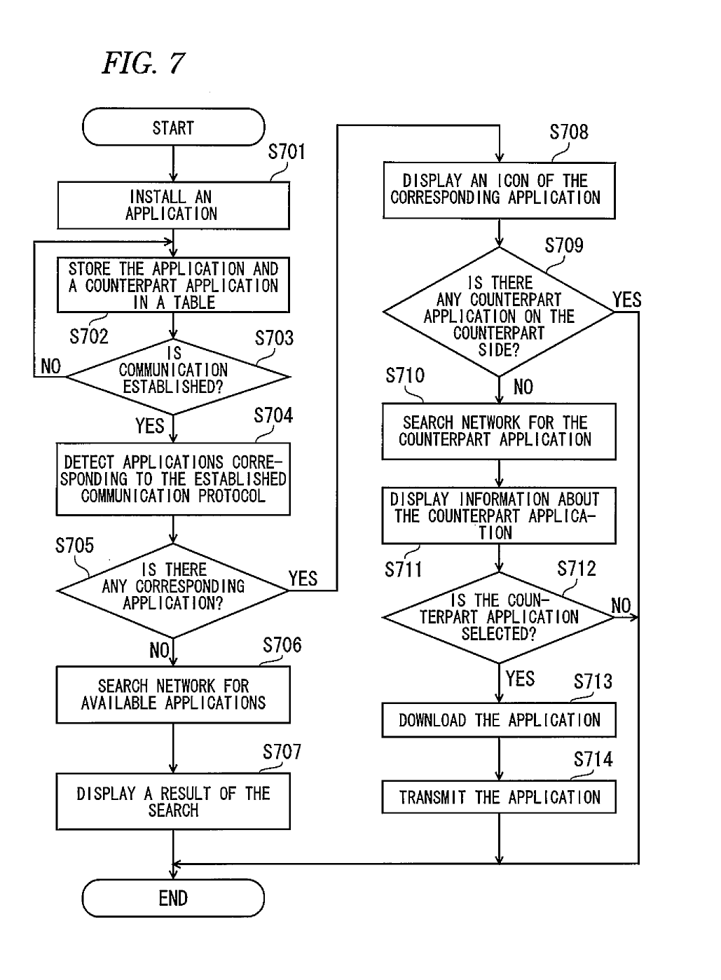

FIG. 7 is a flow chart showing an example of the flow of processing performed by the mobile device 1 in the embodiment.

First, the control module 11 serves as an installation module to acquire an application through the network I/F 14 or by another method and install the application in the mobile device 1 (step S701).

After the installation, the control module 11 acquires information of a communication protocol and a counterpart application to be used, from meta data of the installed application, and stores the information in the table 18 so that the information is associated with the information of the application (step S702). In other words, the control module 11 serves as a storage module which stores the relationship (correspondence) in the nonvolatile memory 12 which is a storage medium.

Then, the mobile device 1 waits for establishment of communication using the first communication module 16 or the second communication module 17 (step S703).

While communication is not established in the step S703 (No in the step S703), the mobile device 1 keeps on waiting. When communication is established (Yes in the step S703), the control module 11 determines, based on the table 18, whether there is any application corresponding to the established communication protocol in the table 18 or not (step S705). That is, the control module 11 serves as a detection module which detects any application corresponding to the communication protocol of the established communication, from the table 18.

When there is no corresponding application (No in the step S705), the control module 11 searches for applications allowed to use the communication protocol of the established communication, through the network I/F 14 (step S706).

When applications allowed to use the currently established communication protocol are detected from the network, the control module 11 displays a result of the searching in the display device 15. When the user finds an application that the user wants to use based on the search result, the user may preferably download and install this application.

When there is any corresponding application in the step S705 (Yes in the step S705), the control module 11 displays an icon of the corresponding application in the display device 15 (step S708).

Then, the control module 11 uses the established communication to determine whether a counterpart application is installed in a counterpart communication device (the PC 2 in the embodiment) or not (step S709). As a determination procedure performed here, the control module 11 first detects a counterpart application corresponding to the application in accordance with the established communication protocol from the table 18. Then, the control module 11 makes an inquiry as to whether the counterpart application corresponding to the application is present in the PC 2 or not. The control module 11 determines, based on a result of the inquiry, whether the counterpart application is installed in the PC 2 or not.

When the determination in the step S709 concludes that the counterpart application is not installed in the counterpart communication device (No in the step S709), the control module 11 serves as a search module which searches the network for a counterpart application (step S710).

When the search is completed in the step S710, the control module 11 displays, in the display device 15, information about the counterpart application to be installed in the PC 2 (step S711).

When the counterpart application displayed in the step S711 is selected (Yes in step S712), the control module 11 serves as a download module which downloads the selected counterpart application from the network (step S713).

When the download is completed, the control module 11 serves as a transmission module which transmits the counterpart application to the PC 2 by the established communication protocol (step S714). Accordingly, because the PC 2 per se need not download the counterpart application and is able to acquire the counterpart application, the counterpart application are able to perform data exchange with the application of the mobile device 1 when the counterpart application is installed in the PC 2.

Although the embodiment has been described when the mobile device 1 acquires a counterpart application and transmits the counterpart application to the PC 2 by way of example, embodiments are not limited thereto. For example, the mobile device 1 may transmit not the counterpart application per se but information about the counterpart application. In this case, when the PC 2 acquires the counterpart application from the network etc. based on the received data, the application is able to be acquired and installed in the PC 2 easily.

After completion of the step S707, when the determination in the step 709 concludes that the counterpart application has been installed in the counterpart communication device (Yes in the step S709), when the counterpart application displayed in the step S711 is not selected (No in the step S712), or after completion of the step S714, the flow of a series of processes is terminated.

In the embodiment, when there is no application using the established communication protocol, the mobile device 1 is able to acquire applications using the established communication protocol from the network and display the applications to the user. In this manner, the mobile device 1 is able to recommend the applications using the established communication protocol to the user. Thus, the user is able to use the established communication protocol (communication protocol available by the mobile device 1), so that this contributes to user-friendliness.

Moreover, the mobile device 1 in the embodiment is able to search for a counterpart application corresponding to the application to be used, and to present the counterpart application to the user. Because the user can use the information so that the counterpart application can be installed in the PC 2, the user can use appropriately the application installed in the mobile device 1.

In addition, the mobile device 1 is able to download the counterpart application from the network and transmit the counterpart application to the PC 2. In this manner, the PC 2 is able to acquire the counterpart application while the PC 2 is not connected to the network.

Because the mobile device 1 in the embodiment has the table 18 indicating relationship between communication protocols and applications, each application for performing communication with another device and a communication protocol used by the application is able to be managed properly.

While a certain embodiment has been described, this embodiment has been presented by way of example only, and is not intended to limit the scope of the inventions. Indeed, the novel embodiment described herein may be embodied in a variety of other forms; furthermore, various omissions, substitutions and changes in the form of the embodiment described herein may be made without departing from the spirit of the inventions. The accompanying claims and their equivalents are intended to cover such forms or modifications as would fall within the scope and spirit of the inventions.

What is claimed is:

1. A communication device comprising:
a communication module configured to communicate with an external device based on a certain communication protocol;
an installation module configured to install a first application using the communication module for performing communication; and
a storage module configured to store first information about the certain communication protocol and second information about the first application in a storage medium while associating the first information and the second information with each other when the first application is installed.

2. The communication device according to claim 1, wherein the storage module is configured to store the first information and the second information associated with each other as table data in the storage medium.

3. The communication device according to claim 1 further comprising:
a detection module configured to detect an application stored in the storage medium and associated with the certain communication protocol when communication based on the certain communication protocol is established; and
a display device configured to display third information indicating the detected application.

4. The communication device according to claim 3, wherein the display device is configured to display the third information as an icon.

5. The communication device according to claim 3 further comprising:
a starter module configured to start up an application when the third information indicating the application displayed on the display device is selected.

6. The communication device according to claim 1 further comprising:
a detection module configured to detect an application stored in the storage medium in association with the certain communication protocol when communication based on the certain communication protocol is established by the communication module; and
a search module configured to search a network for the detected application.

7. The communication device according to claim 1, wherein the storage module is configured to store, in the storage medium, the first information about the certain communication protocol, the second information about the first application and fourth information about a second application necessary for the external device in communication of the first application with the external device while associating the first information, the second information and the fourth information with one another when the first application is installed.

8. The communication device according to claim 7 further comprising:
a detection module configured to detect an application necessary for the external device in communication of the application associated with the certain communication protocol and stored in the storage medium with the external device when communication based on the certain communication protocol is established; and
a search module configured to search a network for the detected application.

9. The communication device according to claim 8 further comprising:
a download module configured to download the application searched for by the search module; and
a transmission module configured to transmit the application downloaded by the download module to the external device.

10. A management method comprising:
installing an application for communicating with an external device based on a certain communication protocol; and
storing first information about the certain communication protocol and second information about the application while associating the first information and the second information with each other when the application is installed.
